(19) United States
(12) Patent Application Publication
(10) Pub. No.: US 2020/0058230 A1
(43) Pub. Date: Feb. 20, 2020

(54) Methods and Systems for Improving Mastery of Phonics Skills

(71) Applicant: Reading Research Associates, Inc., Pittsford, NY (US)

(72) Inventors: Michelle Kristin Hosp, Amherst, MA (US); Michael Lawrence McCarthy, JR., Lancaster, NY (US); Thomas Evan Miller, Pittsford, NY (US)

(21) Appl. No.: 16/532,873

(22) Filed: Aug. 6, 2019

Related U.S. Application Data
(60) Provisional application No. 62/718,413, filed on Aug. 14, 2018.

(51) Int. Cl. G09B 17/00

(52) U.S. Cl. CPC G09B 17/003

(57) ABSTRACT

A word selection module of an assessment engine executed by a first computing device selects a word from a word database and modifies an administrator user interface displayed by the first computing device to include a display of the selected word and an interface element for scoring the selected word. The assessment engine modifies a subject user interface displayed by a second computing device to an assessment subject, to display the selected word. A feedback analysis module of the assessment engine receives an input to the administrator user interface and determines that the input indicates the assessment subject incorrectly read the selected word. A diagnoses module diagnoses a level of mastery of a phonics skill of the assessment subject. The assessment engine modifies the administrator user interface to include an identification of an activity for improving the diagnosed level of mastery.

### CROSS-REFERENCE TO RELATED APPLICATION

This application claims priority from U.S. Provisional Patent Application No. 62/718,413, filed on Aug. 14, 2018, entitled “Methods and Systems for Improving Mastery of Phonics Skills,” which is hereby incorporated by reference.

### BACKGROUND

The disclosure relates to improving mastery of phonics skills. More particularly, the methods and systems described herein relate to functionality for improving mastery of phonics skills following a computer-based, screening and diagnostic phonics assessment.

Conventional reading assessments typically provide an identification of a student at risk of not being successful at some point during the process of learning to read and provide a prediction of a general outcome regarding reading rates and accuracy. However, such assessments do not typically also provide diagnostic information—the assessment may indicate a likelihood of a poor outcome but cannot provide a diagnosis of what specific skill or subskill the subject of the assessment is failing to master and what work can be done to improve the subject's mastery of that skill.

Conventionally, diagnostic tests that can determine a skill in which a subject is deficient are time-consuming and require specialists to administer lengthy diagnostic tests in order to make a determination of skill. However, such diagnostic tests do not typically diagnose phonics skills nor do they typically provide detailed information regarding which specific phonics skills or subskills or letter patterns or letters the test subject struggles to master, nor do they identify what action can be taken for the subject to improve a level of mastery in a phonics skill.

### BRIEF SUMMARY

A method for improving mastery of phonics skills following a computer-based, screening and diagnostic phonics assessment includes selecting, by a word selection module of an assessment engine executed by a first computing device, a word from a word database. The method includes modifying, by the assessment engine, an administrator user interface displayed by the computing device to include a display of the selected word and an interface element for scoring the selected word. The method includes modifying, by the assessment engine, a subject user interface displayed by a second computing device to an assessment subject, the modification resulting in display of the selected word in the subject user interface. The method includes receiving, by a feedback analysis module of the assessment engine, an input to the administrator user interface. The method includes determining, by the feedback analysis module, that the input indicates the assessment subject incorrectly read the selected word. The method includes providing, by the feedback analysis module, to a diagnoses module of the assessment engine, the selected word and a subset of the input. The method includes diagnosing, by the diagnoses module, a level of mastery of a phonics skill of the assessment subject based upon the provided subset of the input. The method includes modifying, by the assessment engine, the administrator user interface to include a display of the diagnosed level of mastery and an identification of an activity for improving the diagnosed level of mastery.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting an embodiment of a system for improving mastery of phonics skills following a computer-based, screening and diagnostic phonics assessment;

FIG. 0 is a block diagram depicting an embodiment of a database of words and word-related information in a system for improving mastery of phonics skills following a computer-based, screening and diagnostic phonics assessment;

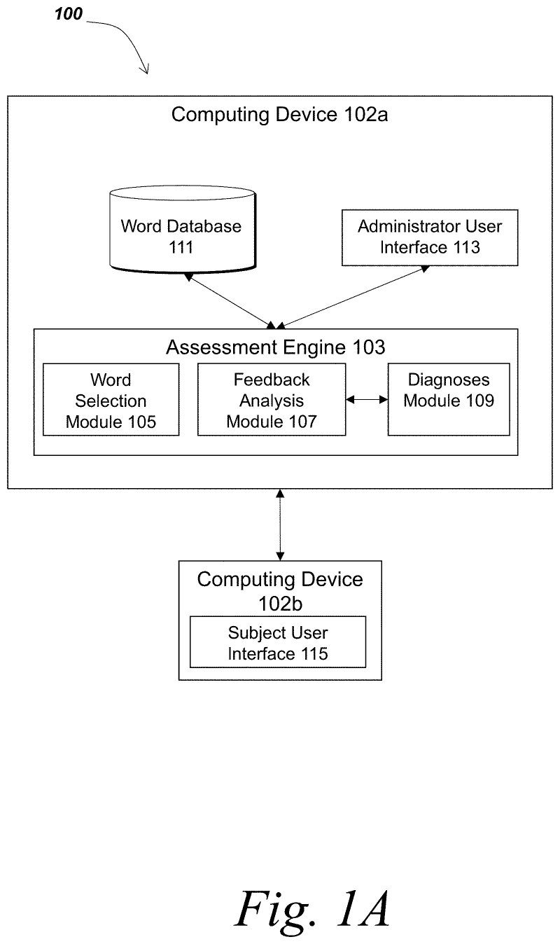

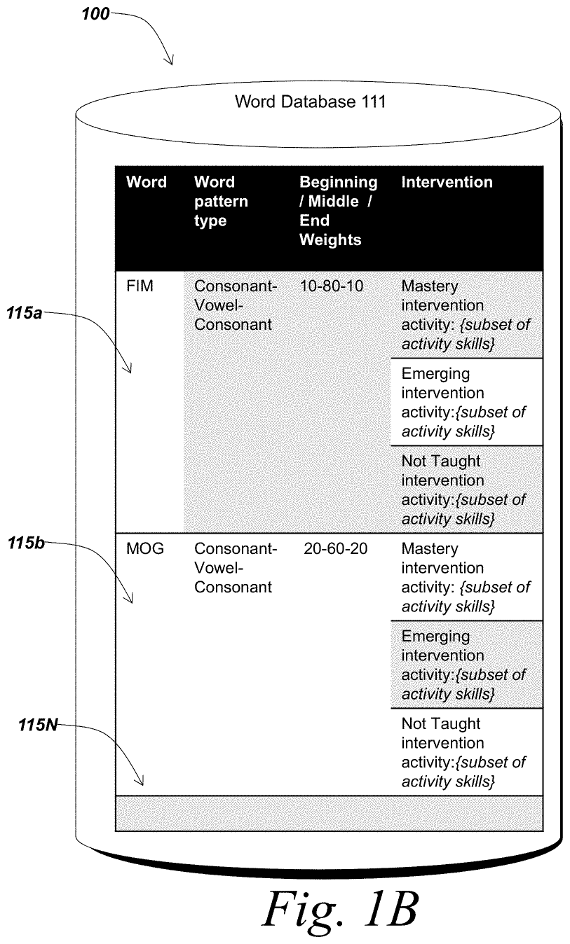

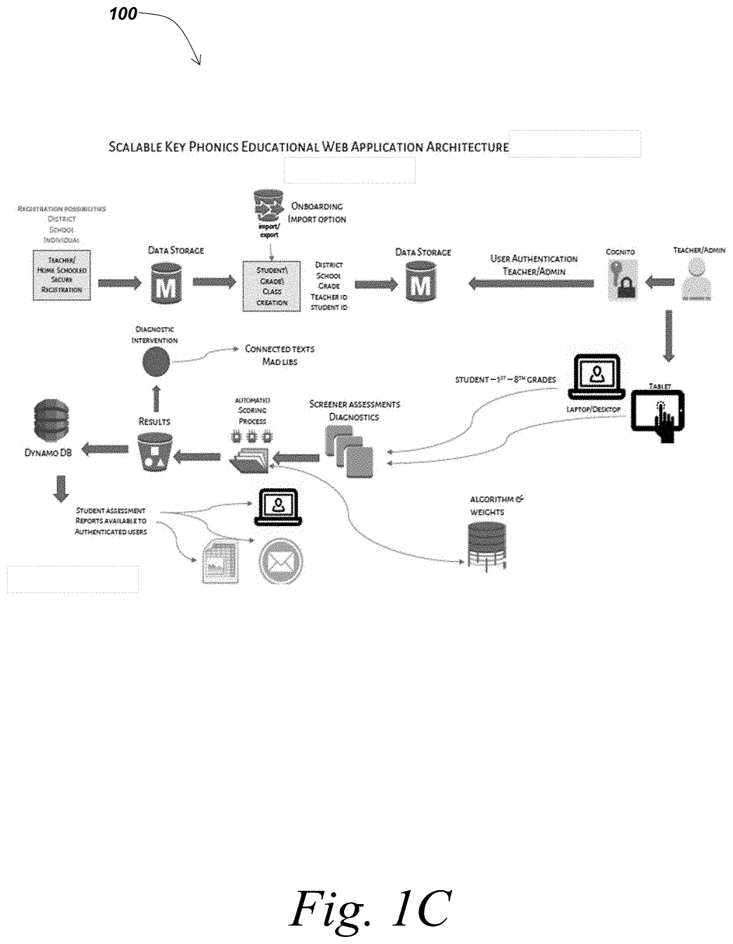

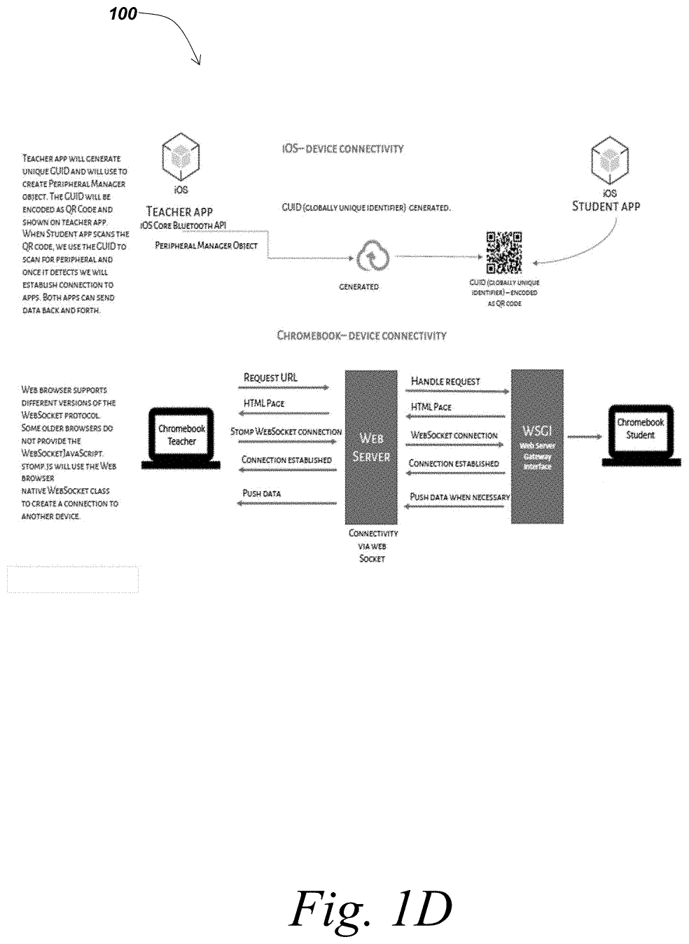

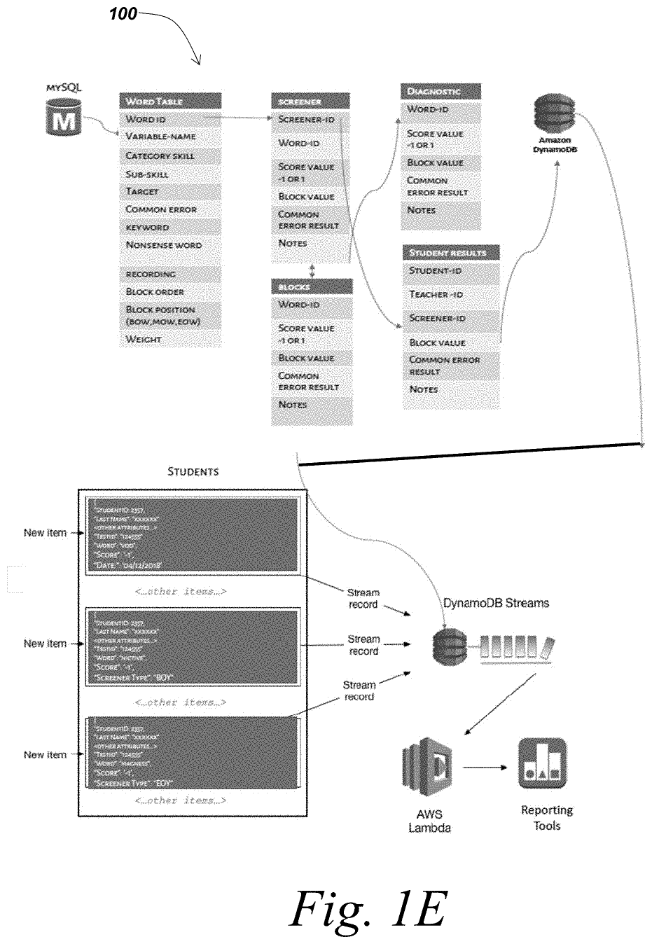

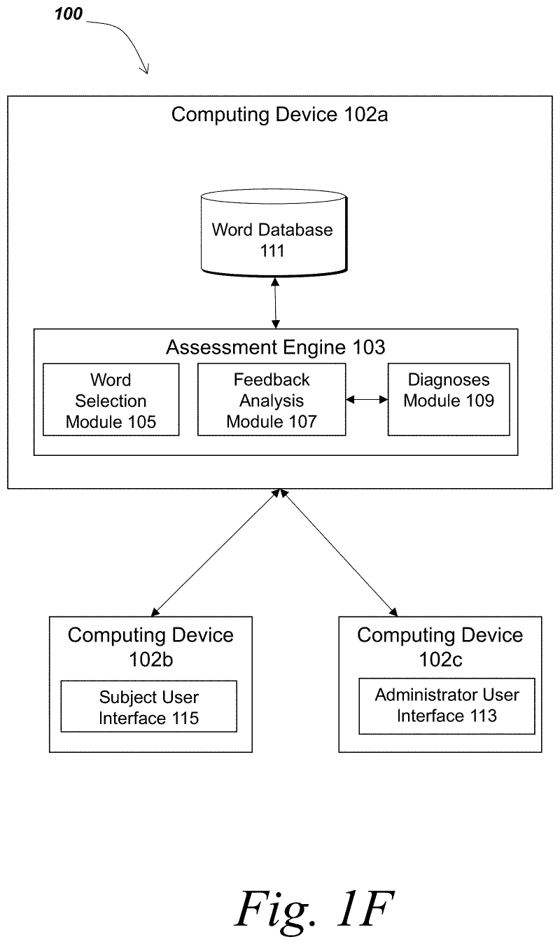

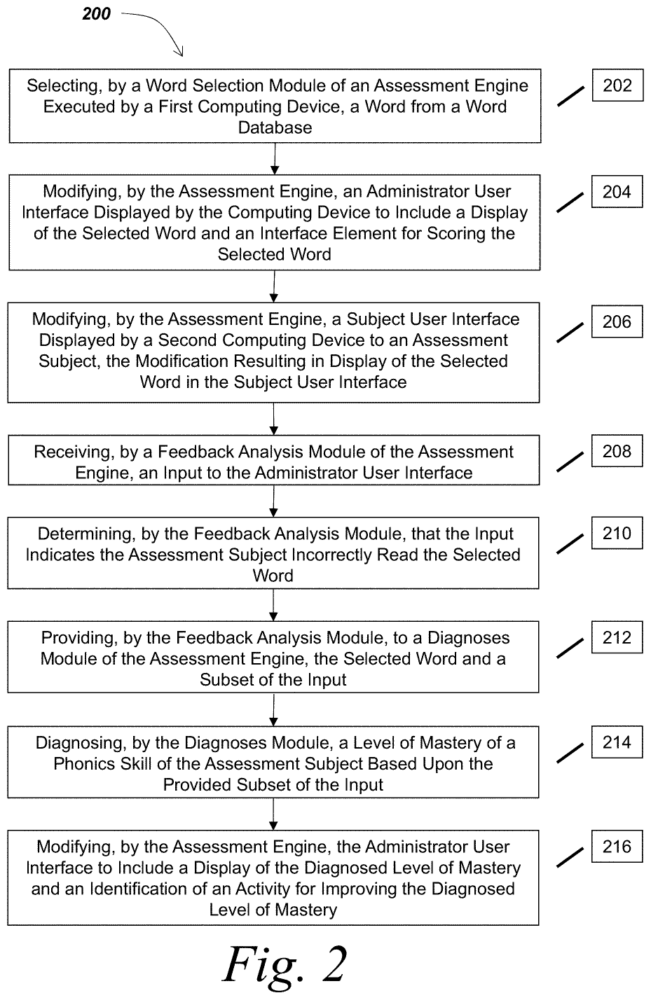

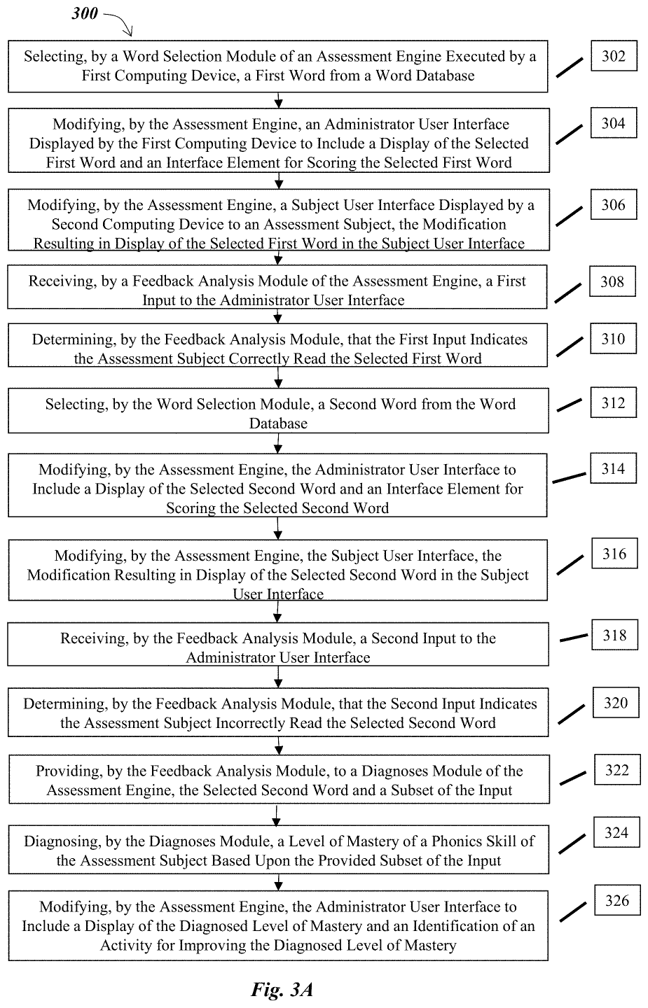

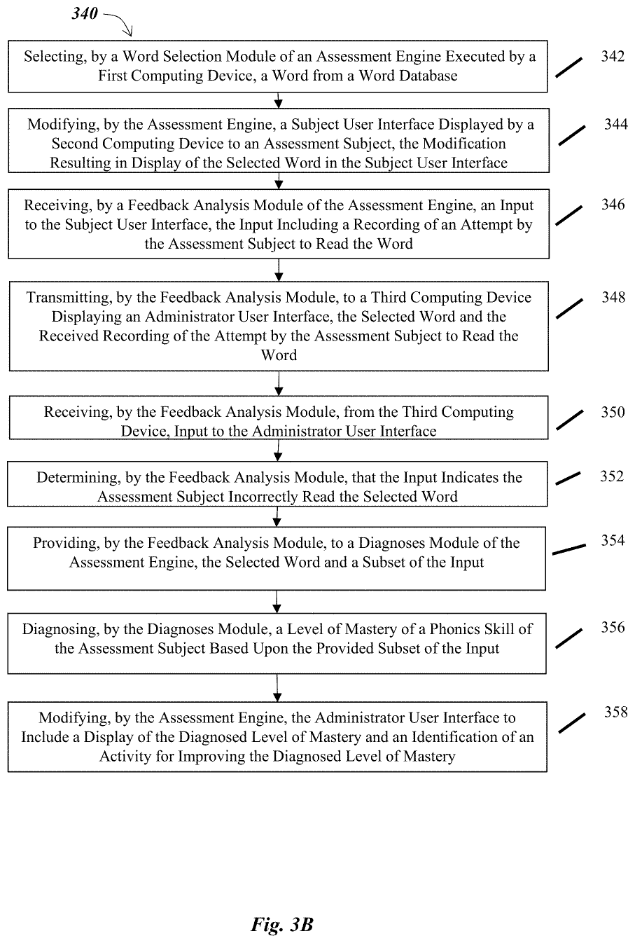

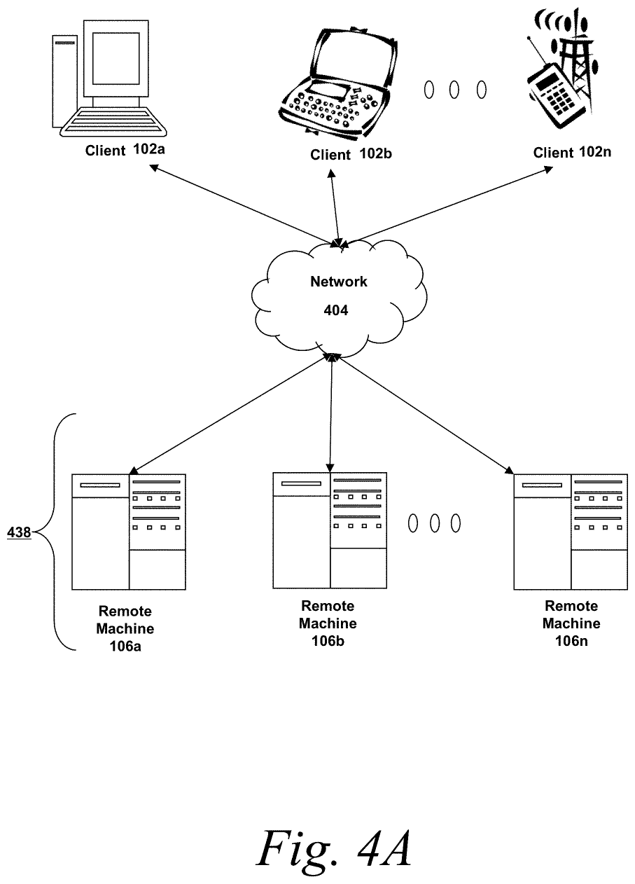

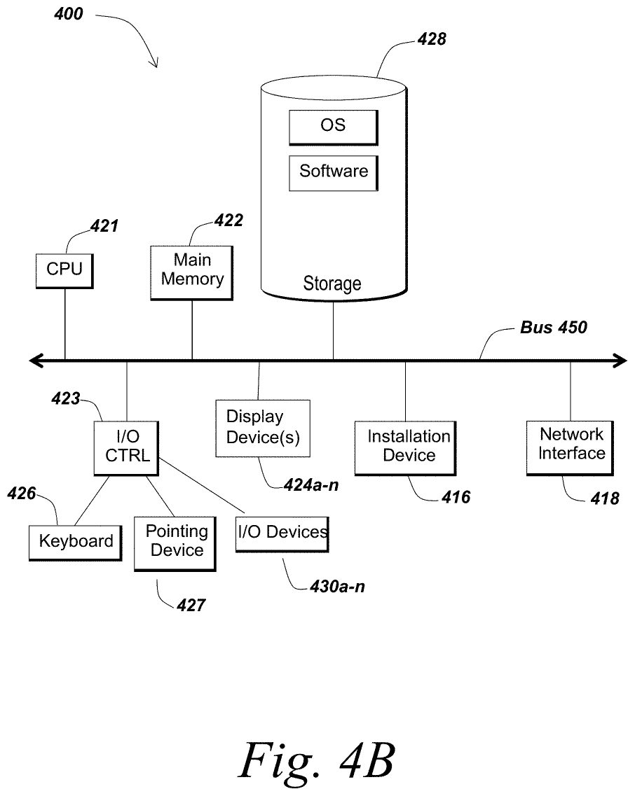

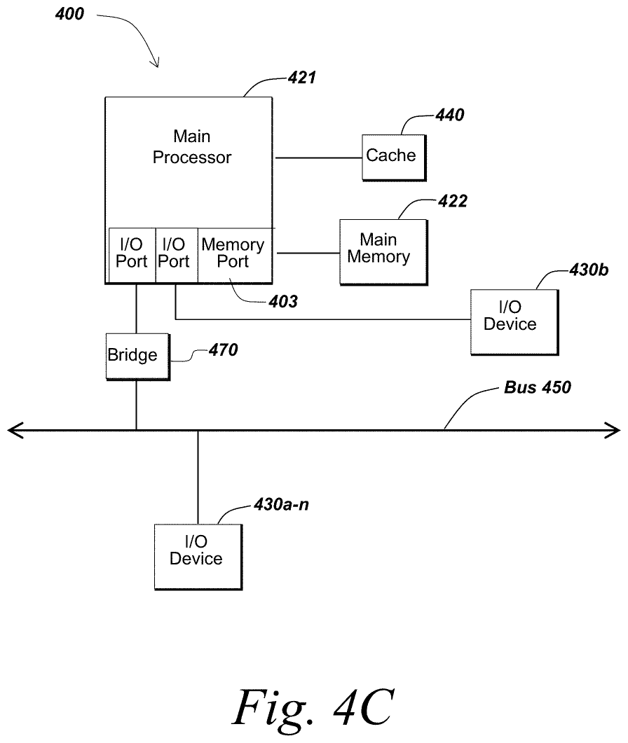

FIG. 1C is a block diagram depicting one embodiment of a system for improving mastery of phonics skills following a computer-based, diagnostic phonics assessment;

FIG. 1D is a block diagram depicting an embodiment of interaction between computing devices used by assessment subjects and administrators in a system for improving mastery of phonics skills following a computer-based, diagnostic phonics assessment;

FIG. 1E is a block diagram depicting an embodiment of data that may be stored in one or more word databases associating particular words with values in either a screening mode or a diagnostic mode and with a subject's scores in an assessment;

FIG. 1F is a block diagram depicting an embodiment of a system for improving mastery of phonics skills following a computer-based, screening and diagnostic phonics assessment;

FIG. 2 is a flow diagram depicting an embodiment of a method for improving mastery of phonics skills following a computer-based, screening and diagnostic phonics assessment;

FIG. 3A is a flow diagram depicting an embodiment of a method for improving mastery of phonics skills following a computer-based, screening and diagnostic phonics assessment;

FIG. 3B is a flow diagram depicting an embodiment of a method for improving mastery of phonics skills following a computer-based, screening and diagnostic phonics assessment performed at a location remote from an assessment subject, the method comprising; and

FIGS. 4A-4C are block diagrams depicting embodiments of computers useful in connection with the methods and systems described herein.

### DETAILED DESCRIPTION

In some embodiments, the methods and systems described herein provide functionality for improving mastery of phonics skills following a computer-based, screening and diagnostic phonics assessment.

Referring now to FIG. 1A, in brief overview, the system 100 includes a computing device 102a, a computing device 102b, an assessment engine 103, a word selection module 105, a feedback analysis module 107, a diagnosis module 109, a word database 111, an administrator user interface 113, and a subject user interface 115.

Referring now to FIG. 1A, and in greater detail, the system 100 includes an assessment engine 103. In some embodiments, the assessment engine 103 is a software program. In other embodiments, the assessment engine 103 is a hardware module. In still other embodiments, the assessment engine 103 executes on the computing device 102, which may be a machine 100 as described below in connection with FIGS. 4A-C and modified by the installation of the computer-readable instructions to execute the assessment engine 103.

The system 100 includes a word selection module 105. In some embodiments, the word selection module 105 is a software program. In other embodiments, the word selection module 105 is a hardware module. In still other embodiments, the word selection module 105 executes on the computing device 102, which may be a machine 100 as described below in connection with FIGS. 4A-C and modified by the installation of the computer-readable instructions to execute the word selection module 105. The word selection module 105 may be in communication with the assessment engine 103. The assessment engine 103 may provide the functionality of the word selection module 105.

The system 100 includes a feedback analysis module 107. In some embodiments, the feedback analysis module 107 is a software program. In other embodiments, the feedback analysis module 107 is a hardware module. In still other embodiments, the feedback analysis module 107 executes on the computing device 102, which may be a machine 100 as described below in connection with FIGS. 4A-C and modified by the installation of computer-readable instructions to execute the feedback analysis module 107. The feedback analysis module 107 may be in communication with the assessment engine 103. The assessment engine 103 may provide the functionality of the feedback analysis module 107.

The system 100 includes a diagnoses module 109. In some embodiments, the diagnoses module 109 is a software program. In other embodiments, the diagnoses module 109 is a hardware module. In still other embodiments, the diagnoses module 109 executes on the computing device 102, which may be a machine 100 as described below in connection with FIGS. 4A-C and modified by the installation of the computer-readable instructions to execute the diagnoses module 109. The diagnoses module 109 may be in communication with the assessment engine 103. The assessment engine 103 may provide the functionality of the diagnoses module 109.

The system 100 includes an administrator user interface 113. The administrator user interface 113 may be a graphical user interface generated by the assessment engine 103 and displayed by the computing device iota. The assessment engine 103 may automatically update the administrator user interface 113 to display different or additional information for use in performing a diagnostic phonics assessment, reviewing information associated with completed diagnostic phonics assessments, or for accessing functionality for improving mastery of one or more phonics skills. The assessment engine 103 may dynamically update the administrator user interface 113 to display different or additional information for use in performing a diagnostic phonics assessment, reviewing information associated with completed diagnostic phonics assessments, or for accessing functionality for improving mastery of one or more phonics skills.

As depicted in FIG. 1F, although the administrator user interface 113 may execute on the same computing device iota as the assessment engine 104, in some embodiments, the administrator user interface 113 executes on a third computing device 102C. As an example, the assessment engine 103 may execute on a first computing device while the administrator user interface 113 and the subject user interface 115 are each displayed on separate devices. For instance, the assessment engine 103 and the word database 111 may execute on a school server while the administrator user interface 113 is displayed on a teacher's tablet, mobile device, or other handheld computing device and the subject user interface 115 is displayed on a student's tablet, mobile device, or other handheld computing device.

The system 100 includes a subject user interface 115. The subject user interface 115 is displayed by the computing device 102b. The system 100 may include a separate application that executes on the computing device 102b and communicates with the assessment engine 103 over a computer network to receive data including instructions for what to display in the subject user interface 115. Alternatively, the system 100 may include a web server 106 (not shown) that hosts a web page providing the subject user interface 115, which the computing device 102b may access resulting in the display of the subject user interface on the computing device 102b. As another alternative, the system 100 may include software that is added to an existing application available on the computing device 102b in order to display the subject user interface 115 (e.g., the system 100 may make a plug-in available for download with which the subject user interface 115 may be displayed). The system 100 provides functionality allowing the assessment engine 103 to provide instructions regarding a selected word to be displayed by the subject user interface 115.

In some embodiments, the word database 111 is an ODBC-compliant database. For example, the word database 111 may be provided as an ORACLE database, manufactured by Oracle Corporation of Redwood Shores, Calif. In other embodiments, the word database 111 can be a Microsoft ACCESS database or a Microsoft SQL server database, manufactured by Microsoft Corporation of Redmond, Wash. In other embodiments, the word database 111 can be a SQLite database distributed by Hwaci of Charlotte, N.C., or a PostgreSQL database distributed by The PostgreSQL Global Development Group. In still other embodiments, the word database 111 may be a custom-designed database based on an open source database, such as the MYSQL family of freely available database products distributed by MySQL AB Corporation of Uppsala, Sweden. In other embodiments, examples of databases include, without limitation, structured storage (e.g., NoSQL-type databases and BigTable databases), HBase databases distributed by The Apache Software Foundation of Forest Hill, Md., MongoDB databases distributed by ioGen, Inc., of New York, N.Y., an AWS DynamoDB distributed by Amazon Web Services and Cassandra databases distributed by The Apache Software Foundation of Forest Hill, Md. In further embodiments, the word database 111 may be any form or type of database.

Although, for ease of discussion, the assessment engine 103, the word selection module 105, the feedback analysis module 107, the diagnosis module 109, the word database in, the administrator user interface 113, and the subject user interface 115 are described as separate modules, it should be understood that this does not restrict the architecture to a particular implementation. For instance, these components may be encompassed by a single circuit or software function or, alternatively, distributed across a plurality of computing devices.

Referring now to FIG. 2, a block diagram depicts one embodiment of a method 200 for improving mastery of phonics skills following a computer-based, screening and diagnostic phonics assessment. In brief overview, the method 200 includes selecting, by a word selection module of an assessment engine executed by a first computing device, a word from a word database (202). The method 200 includes modifying, by the assessment engine, an administrator user interface displayed by the computing device to include a display of the selected word and an interface element for scoring the selected word (204). The method 200 includes modifying, by the assessment engine, a subject user interface displayed by a second computing device to an assessment subject, the modification resulting in display of the selected word in the subject user interface (206). The method 200 includes receiving, by a feedback analysis module of the assessment engine, an input to the administrator user interface (208). The method 200 includes determining, by the feedback analysis module, that the input indicates the assessment subject incorrectly read the selected word (210). The method 200 includes providing, by the feedback analysis module, to a diagnoses module of the assessment engine, the selected word and a subset of the input (212). The method 200 includes diagnosing, by the diagnoses module, a level of mastery of a phonics skill of the assessment subject based upon the provided subset of the input (214). The method 200 includes modifying, by the assessment engine, the administrator user interface to include a display of the diagnosed level of mastery and an identification of an activity for improving the diagnosed level of mastery (216).

Referring now to FIG. 2 in greater detail, and in connection with FIG. 1, the method 200 includes selecting, by a word selection module of an assessment engine executed by a first computing device, a word from a word database (202). In some embodiments, the word selection module 105 selects a plurality of words that will be used in one or more assessments. For example, the assessment engine 103 may provide an indication of a number of words to select from a set of words and the word selection module 105 accesses a database of words and provides the selected number of words to the assessment engine 103. As another example, the assessment engine 103 may provide an indication of a type of assessment the assessment engine 103 is generating and the word selection module 105 determines a number of words to select based on that indication (e.g., by accessing a mapping between assessment types and numbers of words to select). The word selection module 105 may select a number of words based on characteristics of an assessment being administered—such as a grade level of one or more students being assessed or a time of year at which the students are being assessed or a combination of these and other factors. The word selection module 105 may provide the words to the assessment engine 103 for use in creating an assessment using the selected words to be given to each of the students being assessed. As shown in FIG. 1B, the word database 111 may store words available for selection by the word selection module 105 and may include an identification of a word 115a-N (e.g., nonsense words such as “fim” or “mog,” which, nonetheless, exhibit a particular pattern type and may be used to gauge a subject's level of mastery of a category of phonics skills); the word database 111 may also associate words with subsets of activity skills that may be recommended.

The word selection module 105 may select one or more words based on a time of year. For example, the word selection module 105 may identify a time of year at which the assessment is being given—for example, by identifying a time of year at which the word selection module 105 is selecting the word—and identify a type of word associated with the identified time of year and then select a word of the type associated with the identified time of year. For example, the word selection module 105 may receive a date (either from a user or by querying the computing device iota for a system time or by querying the assessment engine 103) and use the date to identify the type of word to select. Continuing with this example, the word selection module 105 may determine that if the current month is September or October, the type of word to select is a word categorized as a “Beginning of Year” word, whereas if the word selection module 105 determines that the current month is May or June, the type of word to select is a word categorized as an “End of Year” word. As a further example, the assessment engine 103 may provide the word selection module 105 with input received from the computing device iota regarding a current system time, which the word selection module 105 maps to an identification of what type of word to select (e.g., by querying a data structure that associates dates with word types such as “Beginning of Year” words, “Middle of Year” words, “End of Year” words, “Summer Session” words, and “off-cycle” words). As an alternative, a user of the system 100 may specify what type of words to use (for example, by entering into a user interface element of the administrator user interface 113 that the words should be of a particular type). The time of year may be any portion of a calendar period specified by an administrator.

Therefore, selecting a word may include identifying a time of year at which the word selection module is selecting the word; identifying a type of word associated with the identified time of year; and selecting a word of the type associated with the identified time of year. Selecting the word may include identifying a time of year that is a month associated with a portion of an academic calendar. Selecting the word may include identifying a time of year that is a month associated with a portion of a summer session. Selecting the word may include identifying a time of year that is a month associated with a portion of a calendar year and independent of an academic calendar. Selecting the word may include identifying a grade level of the assessment subject; identifying a type of word associated with the identified grade level; and selecting a word of the type associated with the identified grade level

The word selection module 105 may specify an order in which the words are to be administered in an assessment. For example, the word selection module 105 may determine that the time of year is associated with “Middle of Year” types of words and determine that the order in which the words are presented in the assessment should be different than the order in which the words are presented when they are “Beginning of Year” types of words.

The type of word may indicate not just a time of year at which the assessment is being administered, as described above, but a type of word having a phonics characteristic a student is expected to have mastered. The word selection module 105 may access additional data to select a word of a type a student is expected to have mastered. As an example, the assessment engine 103 may categorize a set of words as words that should be used in an assessment given at the beginning of the year (e.g., for this set of students, use these 36 words in September) and then further categorize each word based on the grade level (e.g., of the 36 words that will be administered, words of a certain type should be administered at the beginning of the assessment for second graders at the beginning of the year because they are expected to have already mastered the phonics skills required to read those words in September). The same set of words may be administered in a different order for younger or older students, based on an indication of whether and when the students are expected to have mastered the underlying phonics skills.

The word selection module 105 may therefore alternatively, or in addition to selecting a type of word based on a time of year, identify a student grade level of one or more students to whom the assessment is being given. For example, the word selection module 105 may receive an identification of a grade level from the assessment engine 103, which may have received the identification as input to the administrator user interface 113. As another example, the word selection module 105 may determine the grade level based on an analysis of a user identifier of a user accessing the administrator user interface 113 at the time the word selection module 105 is selecting words—for instance, by determining that the user identifier indicates the user is a second grade teacher, the word selection module 105 may select a type of word associated with the identified grade level and select one or more words of the type associated with the identified grade level.

Instead of being categorized based on grade level, the set of words may be categorized based on a curriculum (which may be customized for an academic district, a school, a teacher, a class, a student, or other grouping). Additionally, the set of words may be categorized based on a phonics skill (e.g., a pattern students are learning to read). Therefore, the word selection module 105 may include a pre-determined set of associations between a type of word to use in the assessment and one or more characteristics of the assessment (e.g., grade level of assessment subjects, time of year, number of words, or other selection characteristics). In some embodiments, the administrator user interface 113 includes a user interface element for receiving input to modify an association between a type of word to use in the assessment and one or more characteristics of the assessment. For example, a particular school administrator or teacher may specify that they use a different curriculum than one on which the pre-determined association is based and may modify one or more associations. As another example of available customization, the administrator user interface 113 may include a user interface element allowing a school administrator or teacher to customize the scope and sequence for when they teach a subset of phonics categories. The system 100 may provide additional guidance for customization, including providing functionality for specification of at what grade and time of year all students are expected to have mastered a skill, what grade and time of year all students are expected to be learning but not yet have mastered a skill, and at what grade and time of year are the students not expected to be learning or mastering a skill. The system 100 may also provide functionality for specifying an order in which they expect phonics categories to be mastered; this may either match a reading curriculum or a provided template. By way of example, a school administrator may review a plurality of phonics categories and determines, by grade level and time of year, when skills are expected to be mastered, which skills will have been introduced (and therefore students are expected to be in the process of learning), and which skills will not yet have been taught. In some embodiments, once customization has been completed, the information provided may be used to generate a plan across the grades and times of year for when students are expected to have mastered, be in the process of learning, or not yet know each of the assessed phonics categories. The scope and sequence specified may then be applied to the phonics categories.

By way of illustration, Table 1 below depicts one non-limiting example of a set of phonics categories, target skills associated with each phonics categories, and a number of words per category. As will be understood by those of ordinary skill in the art, additional or alternative phonics categories, target skills, and numbers of words per category may be specified.

TABLE 1

| | | Total Number of |
|---|---|---|
| | | Words per |
| | | Category/ |
| | Target Skills (Total | (Opportunity Per |
| Phonics Category | Number of Target Skills) | Target Skill) |
| 1) Contractions | 'd, n't, 'm, 're, 'll, 's, 've | 18 (3) |
| | (6) | |
| 2) CVC | a, e, i, o, u (5) | 25 (5) |
| (Consonant-Vowel- | | |
| Consonant) | | |
| 3) CVCC (Consonant- | a, e, i, o, u (5) | 25 (5) |
| Vowel-Consonant- | | |
| Consonant) | | |
| 4) Digraphs | sh, ng, ck, ph, wh, th, ch | 35 (5) |
| | (7) | |
| 5) Blends | fl, bl, st, br, sl, gr, sp, pl, | 70 (5) |
| | dr, sk, tr, cl, sn, cr (14) | |
| 6) CVCe (Consonant- | a, i, o, u (4) | 20 (5) |
| Vowel-Consonant- | | |
| silent e) | | |
| 7) R-Control Vowel | ar, ur, or, ir, er (5) | 25 (5) |
| 8) Vowel Teams | ai, oi, ee, ea, oy, oa, ue, aw, | 48 (3) |
| | ay, igh, ew, oo, oe, au, ou, | |
| | ow (16) | |
| 9) CVCCVC | a/i, u/a, o/e, i/o, e/u (5) | 25 (5) |
| (Consonant-Vowel- | | |
| Consonant- | | |
| (Consonant-Vowel- | | |
| Consonant) | | |
| 10) Short Vowel | ful, ed, s, ness, tion, ly, ful | 80 (5) |
| Suffix | ish, ing, ence, er, less, est, | |
| | able, ment, ed, ture (16) | |
| 11) Prefix | mis, ex, in, con, ad, be (12) | 60 (5) |
| 12) Long Vowel | y, est, er, tion, ent, ing, s/es | 21 (3) |
| Suffix | (7) | |

Having selected one or more words, the word selection module 105 provides the assessment engine 103 with access to the word or words for use in displaying an assessment.

The method 200 includes modifying, by the assessment engine, an administrator user interface displayed by the computing device to include a display of the selected word and an interface element for scoring the selected word (204). The assessment engine 103 may display each of a plurality of words received from the word selection module 105 at the same time. Alternatively, the assessment engine 103 may display a first subset of the plurality of words at a first time and update the display to include a second subset of the plurality of words subsequently (e.g., after the first subset of the plurality of words has been administered). The interface element may also provide guidance to the administrator of the assessment (e.g., playing a sound file so that the administrator knows what the word should sound like when read aloud).

The interface element for scoring the selected word may include a user interface element for indicating whether the subject correctly read the word. The interface element for scoring the selected word may include a user interface element for indicating whether the subject incorrectly read the word. The interface element for scoring the selected word may include a user interface element for indicating a portion of the word the subject of the assessment read incorrectly (e.g., either a part of a word such as the beginning, middle, or end, or a specific letter in the word). The interface element for providing feedback may include a plurality of sub-elements for indicating not just whether the word was read correctly or incorrectly and which letter but also may include functionality for adding notes, making comments, or creating a record of data associated with how the subject read the word. The interface element may include an element, such as a pull-down menu, indicating one or more errors associated with one or more letters (e.g., most common errors associated with each letter). In some embodiments, the system 100 also provides functionality that allows an administrator to record the subject's attempts to read a word and store the recording for subsequent access. The interface element may also include functionality for skipping a word (e.g., not scoring it) entirely or revisiting a skipped word at the end of the functionality.

The method 200 includes modifying, by the assessment engine, a subject user interface displayed by a second computing device to an assessment subject, the modification resulting in display of the selected word in the subject user interface (206). The assessment engine 103 may display each of a plurality of words received from the word selection module 105 at the same time. Alternatively, the assessment engine 103 may display a first subset of the plurality of words at a first time and update the display to include a second subset of the plurality of words subsequently (e.g., after the first subset of the plurality of words has been administered).

The method 200 includes receiving, by a feedback analysis module of the assessment engine, an input to the administrator user interface (208). The administrator user interface 113 may receive the input after the administrator of the assessment has a subject read the displayed word aloud. For example, at a time substantially simultaneously to the administrator user interface 113 showing a word, the subject user interface 115 may show the word and the administrator may ask the subject to read the word aloud. The administrator user interface 113 may transmit, to the feedback analysis module 107, the user input received via the interface element for scoring a word. The feedback analysis module 107 may store the entirety of the input (e.g., in a separate input database not shown in FIG. 1A or as part of the word database 111 in association with a particular word to which the input relates).

The method 200 includes determining, by the feedback analysis module, that the input indicates the assessment subject incorrectly read the selected word (210). For example, based on which check mark box or radio button or other interface element received input, the feedback analysis module 107 may determine that the word was read incorrectly.

The method 200 includes providing, by the feedback analysis module, to a diagnoses module of the assessment engine, the selected word and a subset of the input (212). The feedback analysis module 107 may provide the diagnoses module 109 with the subset of the input. For example, the feedback analysis module 107 may determine that a portion of the input included text-based comments regarding how the subject read the word and determine to store the portion for later access without providing the portion to the diagnoses module 109. Alternatively, the feedback analysis module may provide the selected word and all of the input to the diagnoses module 209.

The method 200 includes diagnosing, by the diagnoses module, a level of mastery of a phonics skill of the assessment subject based upon the provided subset of the input (214). In making the diagnoses, the diagnoses module 109 may provide a criterion score for each of a number of categories of phonics skills indicating a level of mastery (such as mastered/not mastered/not completely mastered, or a score based on a numerical range or based on a color scheme such as green/red/yellow).

Diagnosing may include identifying, by the diagnoses module 109, a pattern associated with the selected word. The diagnoses module 109 may identify a time of year at which the identification of the input is received. The diagnoses module 109 may identify a grade level of the assessment subject. The diagnoses module 109 may assign to each of a plurality of portions of the selected word, a weight selected based upon the identified pattern, the identified time of year, and the identified grade level. The diagnoses module 109 may analyze an identification of the input to the administrator user interface. The diagnoses module 109 may access one or more rules to determine the score based upon analyzed data and identified patterns. The diagnoses module 109 may generate a score for each of the plurality of portions of the selected word based upon the assigned weights and the analysis of the identification of the input. The diagnoses module 109 may determine a level of mastery of the phonics skill of the assessment subject based upon the generated score. The diagnoses module 109 may access one or more rules to determine the level of mastery.

Therefore, diagnosing may include identifying, by the diagnoses module, a pattern associated with the selected word; assigning, by the diagnoses module, to each of a plurality of portions of the selected word, a weight selected based upon the identified pattern; analyzing, by the diagnoses module, the identification of the input to the administrator user interface; generating, by the diagnoses module, a score for each of the plurality of portions of the selected word based upon the assigned weight and the analysis of the identification of the input; and determining a level of mastery of the phonics skill of the assessment subject based upon the generated score.

Diagnosing may include identifying, by the diagnoses module, a pattern associated with the selected word; identifying, by the diagnoses module, a time of year at which the identification of the input is received; assigning, by the diagnoses module, to each of a plurality of portions of the selected word, a weight selected based upon the identified pattern and a weight selected based upon the identified time of year; analyzing, by the diagnoses module, the identification of the input to the administrator user interface; generating, by the diagnoses module, a score for each of the plurality of portions of the selected word based upon the assigned weight and the analysis of the identification of the input; and determining a level of mastery of the phonics skill of the assessment subject based upon the generated score.

Diagnosing may include identifying, by the diagnoses module, a pattern associated with the selected word; identifying, by the diagnoses module, a time of year at which the identification of the input is received; identifying, by the diagnoses module, a grade level of the assessment subject; assigning, by the diagnoses module, to each of a plurality of portions of the selected word, a weight selected based upon the identified pattern, the identified time of year, and the identified grade level; analyzing, by the diagnoses module, the identification of the input to the administrator user interface; generating, by the diagnoses module, a score for each of the plurality of portions of the selected word based upon the assigned weights and the analysis of the identification of the input; and determining a level of mastery of the phonics skill of the assessment subject based upon the generated score.

The method 200 includes modifying, by the assessment engine, the administrator user interface to include a display of the diagnosed level of mastery and an identification of an activity for improving the diagnosed level of mastery (216). The diagnoses module 109 may identify the activity for improving the diagnosed level of mastery. Identifying the activity may include identifying a diagnostic that should be administered to the subject. Identifying the activity may include identifying a phonics skill to be mastered based upon specific errors the subject made during the assessment. Identifying the activity may include identifying at least one intervention designed to target at least one error made during the assessment. Identifying the activity may include accessing a mapping between a specific error made by the assessment subject and the identified activity for improving the diagnosed level of mastery. By way of example, the method 200 may include selecting an activity for improving the diagnosed level of mastery by accessing a mapping between an error in a phonics skill assessment and an indication of whether that phonics skill is a phonics skill the assessment subject should have mastered (e.g., based on curriculum, grade level, and/or time of year) and an indication of an associated activity. As another example, the method 200 may include selecting an activity for improving the diagnosed level of mastery based upon how many errors on the target skill the student made; for example, by accessing a mapping between a number of errors on target skills and the “dose” of the activity (e.g., only two target skill errors may require a shorter number of times the assessment subject should perform the identified activity than five target skill errors). As a further example, the method 200 may include selecting an activity for improving the diagnosed level of mastery by accessing a mapping between an identification of a previous level of performance at the diagnostic level and a current diagnosed level of mastery (e.g., if the student continues to make the same number or errors or more errors on the same target skill, then the intervention dosage may be changed).

In some embodiments, the identification of the activity is an identification of a diagnostic that should be administered to the subject. The identification of the activity may include a method for beginning the activity; for example, by providing a Uniform Resource Locator (URL) that, when selected by a user of the administrator user interface 113, provides access to the activity. The identification of the activity may include an identification of a specific phonics skill to be mastered based upon specific errors the subject made during the assessment. The activity may be one or more interventions that is designed to target at least one error made during the assessment. In some embodiments, automatically updating the administrator user interface 113 with results provides an improved system that does not require the administrator to experience a delay for scoring.

Which diagnostic assessments the system would recommend as an activity for improving a level of mastery may include factors such as whether that phonics category is a category that a student may be expected to have mastered (e.g., based on schools determining their specific scope and sequence by grade and time of year for each of the skills) and how many words of that type a subject got incorrect. Therefore, subjects are only given a diagnostic on a skill they should have mastered but have not yet demonstrated mastery on based on information from the screener. Those skills they did not mastered and would not have expected to master because it is either still being taught or has not yet been taught would not be recommended for the diagnostic. For example, if a student at the beginning of 3rd grade got a score of 2 in the “CVC” (i.e., consonant-vowel-consonant) category when it should have been a 3, the system 100 may indicate the student should have the diagnostic assessment for the CVC category.

The intervention may be customized by weighting the target skills first, then the beginning, middle, and end of word. The target skills the student scored the lowest on would be represented the most (for example, and without limitation, 75%), then those targets the student got some right would be represented (for example, and without limitation, 15%) and those targets the student mastered would be represented (for example, and without limitation, 10%). For example, on a consonant-vowel-consonant type category if the student scored 0, 1, or 2 (out of 5) on vowels e, i, u, and scored 3 or 4 (out of 5) for vowel o, and scored 5 (out of 5) for vowel a, the system 100 would customize the intervention so that, for example, 75% of instruction focused on short e, i, u, 15% on o, and 10% on a. The system 100 would also take into consideration errors the student made at the beginning and end of the word. This way the system 100 may build a customized activity that has words sorts, spelling activities, speed drills, and reading paragraphs that represent the word patterns the particular subject struggles to master. The system 100, therefore, identifies patterns in the assessment subject's errors and customizes one or more interventions based on the identified patterns.

The activity may be based on the errors made on the diagnostic assessment. The system 100 may use a weighting formula on each target skills to build a completely customizable report and an intervention that may include: letter sound identification, letter sound production, word sorts, spelling activities, speed drills, and text reading that matches the patterns the student is struggling with. In one embodiment, by way of non-limiting example, the text reading is similar to an engaging fill-in-the-blank game that will engage the students and also allow for sheets to be printed and taken home for practice.

The methods described herein may be administered for different purposes. For example, the method may be administered in order to provide screening functionality—to determine whether a subject has mastered a phonics skill or not. As another example, the method may be administered in order to provide diagnostics functionality to identify a phonics skill the subject has not mastered and provide a specific diagnoses of what aspect(s) of that skill in particular does the subject struggle with, down to the letter level of the word. The ways in which the assessment engine 103 may vary based on the purpose of the administration of the assessment. For example, in screening, whether a subject read a word correctly or incorrectly may be scored dichotomously (right or wrong), one or more weights may be applied at the level of a skill category type, and the outcome is used to identify a phonics skill that the student needs help with; as an example, in this case, the recommended activity may be, without limitation, to work with a reading specialist on improving a particular phonics skill. As another example, in diagnostics assessments the score may be weighted based on a more granular scale (e.g., parts of words or letters in words) and is used to identify a specific activity to undertake to improve the level of mastery of the skill; the activity may be a particular intervention in which the assessment engine 103 selects a set of words for the user to practice on, each of the selected words selected for its ability to improve an understanding of an aspect of a phonics skill.

As one, non-limiting example of an embodiment in which the method is administered for screening purposes, the word selection module 105 may select three words for each of 12 categories, for a total of 36 words; the same 36 words may be used for every grade level at which the assessment is administered but randomized to provide four different versions of the assessment (e.g., beginning of year, end of year, middle of year, off-cycle). Continuing with this example, the system 100 may require that a subject of an assessment attempt to read all 36 words, regardless of grade level. The assessment (in screening capacity) may be administered multiple times of years to a plurality of subjects (e.g., three times a year to all students). Continuing with this example, the assessment for screening purposes may be administered to subjects individually and take a minimal amount of time (such as 3-5 minutes). Continuing with this example, each of the 36 words may be scored correct or incorrect and a score of 3, 2, 1, or 0 is recorded for each of the 12 categories (of three words each). The system 100 may optionally allow those administering the assessment to provide additional scoring detail, such as scoring at the individual letter level so that they can see where a subject of an assessment made errors. To the extent this information is provided, the system 100 may provide reports based on response that provides the assessor with insight across an individual subject's responses, as well as being able to be combined with multiple subjects' responses and providing a comprehensive view across a plurality of subjects regarding strengths and weaknesses. The information in reports may include information related to the errors students made in attempting to read specific portions of words (including beginning of word, middle of word, and end of word). Continuing with this example, results may be scored differently when used for a screening purpose; for instance, scores in each category may be weighted based on scope and sequence with weights positioned in an order effect that correlates to the taught skill. Continuing with this example, a subject may be given a point per category as long as the student has not scored a value of one or 0 for any word in the category; the student may receive a bonus point for each score of three. Bonus points may be used to rank readers.

As one, non-limiting example of an embodiment in which the method is administered for diagnostic purposes, the assessment may be made up of individual tests for each of a subset of phonics categories. In one embodiment, the same words are used each time the assessment is given and students are required to attempt each word. Each of the 12 phonics categories assesses target skills commonly associated with that specific category. Continuing with this example, based on how the subject scored on the screener, they would be recommended to take, for example, 2-4 diagnostic assessments. Continuing with this example, the assessment for diagnostic purposes may be administered to subjects individually and take a minimal amount of time (such as 3-5 minutes). Continuing with this example, the assessment for diagnostic purposes may be scored at the letter level; a score of, for example, 5, 4, 3, 2, 1, or 0 is recorded for each of the target skills tested in the phonics category. Continuing with this example, the number of target skills and the number of opportunities for each target skill depends on the phonics skill category being tested; there is not a total score but instead each of the target skills would have a score associated with it. Continuing with this example, because the assessment is scored at the letter level, the system 100 may not only report on the target skills but also share and display data based on student errors associated with the Beginning of Word (BOW), Middle of Word (MOW), and End of Word (EOW). Because the diagnostic assessment is scored at the letter level, the system 100 may provide specific information about what the skills are that a subject struggles to master. This may be done by focusing on the target skill within each category. For example, the category CVC and CVCC have the short vowel as the target. The system 100 may measure all 5 short vowels to determine which vowels the student needs the most instruction on, some instruction on and review on. The system 100 may then focus on parts of the word (beginning, middle, and end) and this allows the system 100 to report on specific errors that occur in these positions. If the student missed a “b” at the beginning of the word and replaced it with a “d,” the system 100 may report how many times this happened. This may be done by providing teachers a list of common errors for each letter, as well as allowing teachers to enter the specific error. Continuing with this example, results may be scored differently when used for a diagnostic purpose; for instance, scores in each category may be weighted based on scope and sequence with weights positioned in an order effect that correlates to the taught skill. Particular letters may have more weights based on their importance in mastering a particular skill. Bonus points may be used to rank assessment subjects.

In some embodiments, therefore, the system 100 may include multiple instantiations of an assessment engine 103, each of which may be operating in either a mode for providing screening functionality or in a mode for providing diagnostics functionality. As an example, the system 100 may include at least one assessment engine 103 providing a screening functionality and at least another assessment engine 103 providing a diagnostic functionality; when an assessment administrator completes a screening, for example, and proceeds to take the recommended actions, the recommended actions may include executing a diagnostic functionality and that diagnostic functionality may be provided by either the same assessment engine 103 (having switched to execution in diagnostics mode) or by a different assessment engine 103 that executes in diagnostics mode.

In some embodiments, the system 100 provides functionality for assessing a set of phonics categories representing the most common phonics patterns students need to master to be proficient readers. Within each such category, the system 100 may assess target skills that are most commonly associated with that category. The system 100 may further provide functionality for generating assessments that provide multiple opportunities for every assessed target skill to increase a level of accuracy in a determination regarding whether or not a student has mastered the skill or is in the process of mastering the skill.

The system 100 may provide functionality for generating detailed reports based upon individual and combined assessment results. By way of example, at an individual level, screening data may be displayed in bar graph and reviewed across one year or multiple years. The diagnostic data allows for analysis at the error level, which may then be used to customize intervention. As another example, at a classroom level, a specified scope and sequence (e.g., beginning of year, second grade) is applied to a formula to weigh each category, which allows the system 100 to produce classroom level reports where every student is listed and ranked from the best reader to the most struggling reader; this data may be displayed using the screening data as well as the diagnostic data.

As a further example, reports may be generated at a grade level, school level, or district level; screening data may be displayed in bar graphs showing the number and percentage of students who scored at a particular level for each of a plurality of phonics categories. Continuing with this example, the data may be viewed at the grade level to examine growth across the year (or other period of time) for a particular grade or to examine growth across grades, which is possible because the screening assessment may be based on the use of the same words at every grade (even if in different orders or with different weights) and every student attempts to read every word. The data may be broken down into disaggregated groups. Reporting data may be provided in a searchable form, allowing users to query and filter the data and to generate customized reports.

FIG. 1C is a block diagram depicting one embodiment of a system 100 for improving mastery of phonics skills following a computer-based, diagnostic phonics assessment. As shown in FIG. 1C, the system 100 may further include functionality for authentication, onboarding and importing, and registration, as well as the functionality described above.

FIG. 1D is a block diagram depicting an embodiment of interaction between computing devices used by assessment subjects and administrators in a system 100 for improving mastery of phonics skills following a computer-based, diagnostic phonics assessment. As shown in FIG. 1D, the system 100 may include web-based applications in which subjects and administrators access the assessment and related functionality by connecting to a web server. Alternatively, the administrator may execute an application on a device that generates an identifier associated with a QR code that the subject's device may scan (e.g., using a camera on the subject's device), at which points a connection may be established between the two devices using the QR code.

FIG. 1E is a block diagram depicting an embodiment of data that may be stored in one or more word databases 111 associating particular words with values in either a screening mode or a diagnostic mode and with a subject's scores in an assessment.

It should be understood that the screening and diagnostic assessment described above may include any number of words and that the subject of the assessment may be assessed on any number of words before the diagnosis of the level of mastery of one or more phonics skills is performed. For example, the system may administer all of the words no matter how many of the words the student gets wrong at any point in time. The system may continue the assessment even after the student gets a particular word wrong early in the process.

Referring now to FIG. 3A, in brief overview, a method 300 for improving mastery of phonics skills following a computer-based, diagnostic phonics assessment includes selecting, by a word selection module of an assessment engine executed by a first computing device, a first word from a word database (302). The method 300 includes modifying, by the assessment engine, an administrator user interface displayed by the first computing device to include a display of the selected first word and an interface element for scoring the selected first word (304). The method 300 includes modifying, by the assessment engine, a subject user interface displayed by a second computing device to an assessment subject, the modification resulting in display of the selected first word in the subject user interface (306). The method 300 includes receiving, by a feedback analysis module of the assessment engine, a first input to the administrator user interface (308). The method 300 includes determining, by the feedback analysis module, that the first input indicates the assessment subject correctly read the selected first word (310). The method 300 includes selecting, by the word selection module, a second word from the word database (312). The method 300 includes modifying, by the assessment engine, the administrator user interface to include a display of the selected second word and an interface element for scoring the selected second word (314). The method 300 includes modifying, by the assessment engine, the subject user interface, the modification resulting in display of the selected second word in the subject user interface (316). The method 300 includes receiving, by the feedback analysis module, a second input to the administrator user interface (318). The method 300 includes determining, by the feedback analysis module, that the second input indicates the assessment subject incorrectly read the selected second word (320). The method 300 includes providing, by the feedback analysis module, to a diagnoses module of the assessment engine, the selected second word and a subset of the input (322). The method 300 includes diagnosing, by the diagnoses module, a level of mastery of a phonics skill of the assessment subject based upon the provided subset of the input (324). The method 300 includes modifying, by the assessment engine, the administrator user interface to include a display of the diagnosed level of mastery and an identification of an activity for improving the diagnosed level of mastery (326).

Referring now to FIG. 3A, in connection with FIGS. 1A-1B and 2, and in greater detail, the method 300 for improving mastery of phonics skills following a computer-based, diagnostic phonics assessment includes selecting, by a word selection module of an assessment engine executed by a first computing device, a first word from a word database (302). The method 300 includes modifying, by the assessment engine, an administrator user interface displayed by the first computing device to include a display of the selected first word and an interface element for scoring the selected first word (304). The method 300 includes modifying, by the assessment engine, a subject user interface displayed by a second computing device to an assessment subject, the modification resulting in display of the selected first word in the subject user interface (306). The method 300 includes receiving, by a feedback analysis module of the assessment engine, a first input to the administrator user interface (308). In some embodiments, steps (302), (304), (306), and (308) are performed as described above in connection with FIG. 2 at (202), (204), (206), and (208).

The method 300 includes determining, by the feedback analysis module, that the first input indicates the assessment subject correctly read the selected first word (310). The method 300 includes selecting, by the word selection module, a second word from the word database (312). The method 300 includes modifying, by the assessment engine, the administrator user interface to include a display of the selected second word and an interface element for scoring the selected second word (314). The method 300 includes modifying, by the assessment engine, the subject user interface, the modification resulting in display of the selected second word in the subject user interface (316). The method 300 includes receiving, by the feedback analysis module, a second input to the administrator user interface (318). The method 300 includes determining, by the feedback analysis module, that the second input indicates the assessment subject incorrectly read the selected second word (320). The method 300 includes providing, by the feedback analysis module, to a diagnoses module of the assessment engine, the selected second word and a subset of the input (322). The method 300 includes diagnosing, by the diagnoses module, a level of mastery of a phonics skill of the assessment subject based upon the provided subset of the input (324). The method 300 includes modifying, by the assessment engine, the administrator user interface to include a display of the diagnosed level of mastery and an identification of an activity for improving the diagnosed level of mastery (326). In some embodiments, steps (312), (314), (316), (318), (310), (322), (324), and (316) may be performed as described above in connection with FIG. 2.

As described above, in some embodiments, the assessment engine 103 executes on the same device as the administrator user interface 113 and the scoring of the attempt by the assessment subject to read a selected word is performed at a substantially similar time as the attempt to read the selected word. As shown in the examples provided above, the assessment subject and the assessment administrator may be in close physical proximity to each other (e.g., they may be a student and a teacher together in a classroom). However, the assessment administrator may be at a location physically remote from the assessment subject during the administration of the assessment and/or during the scoring of the assessment. The assessment administrator may also be at a location physically remote from the assessment engine 103. Therefore, an assessment subject may perform an assessment at a first location while the assessment administrator receives a recording of the assessment subject's attempt to read one or more selected word and the assessment administrator scores the assessment (indicating whether the attempt is correct or incorrect) from a second location. By way of example, and without limitation, a home-schooled student may perform an assessment at home and have recordings of the student's attempts to read one or more words sent to a tutor, program administrator, or other assessment administrator at a different location for scoring; the assessment administrator may access an administrator user interface provided by the same computing device 102a that executes the assessment engine 103 (as shown in FIG. 1A) or may access an administrator user interface provided by a third computing device 102C, such as a home or office computer remote from the assessment engine 103 (as shown in FIG. 1F).

Therefore, and referring now to FIG. 3B, a method 340 for improving mastery of phonics skills following a computer-based screening and diagnostic phonics assessment performed at a location remote from an assessment subject may include selecting, by a word selection module of an assessment engine executed by a first computing device, a word from a word database (342); modifying, by the assessment engine, a subject user interface displayed by a second computing device to an assessment subject, the modification resulting in display of the selected word in the subject user interface (344); receiving, by a feedback analysis module of the assessment engine, an input to the subject user interface, the input including a recording of an attempt by the assessment subject to read the word (346); transmitting, by the feedback analysis module, to a third computing device displaying an administrator user interface, the selected word and the received recording of the attempt by the assessment subject to read the word (348); receiving, by the feedback analysis module, from the third computing device, input to the administrator user interface (350); determining, by the feedback analysis module, that the input indicates the assessment subject incorrectly read the selected word (352); providing, by the feedback analysis module, to a diagnoses module of the assessment engine, the selected word and a subset of the input (354); diagnosing, by the diagnoses module, a level of mastery of a phonics skill of the assessment subject based upon the provided subset of the input (356); and modifying, by the assessment engine, the administrator user interface to include a display of the diagnosed level of mastery and an identification of an activity for improving the diagnosed level of mastery (358). Steps (342), (344), (350), (352), (354), (356), and (358) may be performed as described above in connection with (202), (206), (208), (210), (212), (214), and (216) of FIG. 2. Receiving, by the feedback analysis module of the assessment engine, an input to the subject user interface, the input including a recording of an attempt by the assessment subject to read the word, may include receiving a recording generated by the assessment subject (e.g., through the use of a microphone at the computer 100 of the assessment subject to record the assessment subject's utterances); by way of example, the subject user interface may include a user interface element with which the assessment subject may upload a recorded attempt to read the selected word and transmit the uploaded recording to the assessment engine 103. Transmitting, by the feedback analysis module, to a third computing device displaying an administrator user interface, the selected word and the received recording of the attempt by the assessment subject to read the word may include transmitting the selected word and the received recording for scoring by an assessment administrator at a location remote from the assessment subject.

The method 340 includes receiving, by a feedback analysis module of the assessment engine, an input to the subject user interface, the input including a recording of an attempt by the assessment subject to read the word (346). The assessment subject may record his or her voice during the attempt to read the word. The assessment subject may use a user interface element of the subject user interface 115 to transmit the recording to the computing device iota. The feedback analysis module 107 may store the recording. The feedback analysis module 107 may assign an identification number to the stored recording (e.g., using a student name, a student identifier, an anonymous identification number, or other identifier).

The method 340 includes transmitting, by the feedback analysis module, to a third computing device displaying an administrator user interface, the selected word and the received recording of the attempt by the assessment subject to read the word (348). The feedback analysis module 107 may generate a uniform resource locator (which may be, in some embodiments, a secured unique link) that provides a recipient of the uniform resource locator (URL) with access to a user interface for scoring the recorded assessment (e.g., via an administrator user interface 113). For example, the administrator user interface 113 may provide a user interface element listing one or more assessments available for review by the administrator and the administrator may interact with the user interface element to score the one or more assessments.

The method 340 includes receiving, by the feedback analysis module, from the third computing device, input to the administrator user interface (350). By way of example, the administrator receiving the URL from the feedback analysis module 107 may access the recorded assessment through the administrator user interface 113 and provide feedback (including an indication of whether one or more words were read correctly) through the administrator user interface 113. The feedback analysis module 107 may store the scored results. The feedback analysis module 107 may provide the diagnoses module 109 with some or all of the input as described above. The feedback analysis module 107 may notify the assessment subject that the score is available; for example, the feedback analysis module 107 may notify the assessment subject of the score availability via an electronic mail message that contains a URL to a site allowing the assessment subject to access the results.

It should be understood that the systems described above may provide multiple ones of any or each of those components and these components may be provided on either a standalone machine or, in some embodiments, on multiple machines in a distributed system. The phrases ‘in one embodiment,’ ‘in another embodiment,’ and the like, generally mean that the particular feature, structure, step, or characteristic following the phrase is included in at least one embodiment of the present disclosure and may be included in more than one embodiment of the present disclosure. Such phrases may, but do not necessarily, refer to the same embodiment.

The systems and methods described above may be implemented as a method, apparatus, or article of manufacture using programming and/or engineering techniques to produce software, firmware, hardware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be LISP, PYTHON, PROLOG, PERL, C, C++, C #, JAVA, PHP, JavaScript, Node, js or any compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of computer-readable devices, firmware, programmable logic, hardware (e.g., integrated circuit chip; electronic devices; a computer-readable non-volatile storage unit; non-volatile memory, such as semiconductor memory devices, including EPROM, EEPROM, and flash memory devices; magnetic disks such as internal hard disks and removable disks; magneto-optical disks; and CD-ROMs). Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium. A computer may also receive programs and data (including, for example, instructions for storage on non-transitory computer-readable media) from a second computer providing access to the programs via a network transmission line, wireless transmission media, signals propagating through space, radio waves, infrared signals, etc. Therefore, in some embodiments, the systems described herein include a non-transitory, computer-readable medium encoded with computer-executable instructions that, when executed on a computing device, cause the computing device to carry out a method for improving mastery of phonics skills following a computer-based, screening and diagnostic phonics assessment as described in FIGS. 1-3.

Referring now to FIGS. 4A, 4B, and 4C, block diagrams depict additional detail regarding computing devices that may be modified to execution functionality for implementing the methods and systems described above.

Referring now to FIG. 4A, an embodiment of a network environment is depicted. In brief overview, the network environment comprises one or more clients 102a-102n (also generally referred to as local machine(s) 102, client(s) 102, client node(s) 102, client machine(s) 102, client computer(s) 102, client device(s) 102, computing device(s) 102, endpoint(s) 102, or endpoint node(s) 102) in communication with one or more remote machines 106a-106n (also generally referred to as server(s) 106 or computing device(s) 106) via one or more networks 404.

Although FIG. 4A shows a network 404 between the client(s) 102 and the remote machines 106, the client(s) 102 and the remote machines 106 may be on the same network 404. The network 404 can be a local area network (LAN), such as a company Intranet, a metropolitan area network (MAN), or a wide area network (WAN), such as the Internet or the World Wide Web. In some embodiments, there are multiple networks 404 between the client(s) and the remote machines 106. In one of these embodiments, a network 404′ (not shown) may be a private network and a network 404 may be a public network. In another of these embodiments, a network 404 may be a private network and a network 404′ a public network. In still another embodiment, networks 404 and 404′ may both be private networks. In yet another embodiment, networks 404 and 404′ may both be public networks.

The network 404 may be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, an SDH (Synchronous Digital Hierarchy) network, a wireless network, and a wireline network. In some embodiments, the network 404 may comprise a wireless link, such as an infrared channel or satellite band. The topology of the network 404 may be a bus, star, or ring network topology. The network 404 may be of any such network topology as known to those ordinarily skilled in the art capable of supporting the operations described herein. The network 404 may comprise mobile telephone networks utilizing any protocol or protocols used to communicate among mobile devices (including tables and handheld devices generally), including AMPS, TDMA, CDMA, GSM, GPRS, UMTS, or LTE. In some embodiments, different types of data may be transmitted via different protocols. In other embodiments, the same types of data may be transmitted via different protocols.

A client(s) 102 and a remote machine 106 (referred to generally as computing devices 100) can be any workstation, desktop computer, laptop or notebook computer, server, portable computer, mobile telephone, mobile smartphone, or other portable telecommunication device, media playing device, a gaming system, mobile computing device, or any other type and/or form of computing, telecommunications or media device that is capable of communicating on any type and form of network and that has sufficient processor power and memory capacity to perform the operations described herein. A client(s) 102 may execute, operate or otherwise provide an application, which can be any type and/or form of software, program, or executable instructions, including, without limitation, any type and/or form of web browser, web-based client, client-server application, an ActiveX control, or a JAVA applet, or any other type and/or form of executable instructions capable of executing on client(s) 102.

In one embodiment, a computing device 106 provides functionality of a web server. In some embodiments, a web server 106 comprises an open-source web server, such as the NGINX web servers provided by NGINX, Inc., of San Francisco, Calif., or the APACHE servers maintained by the Apache Software Foundation of Delaware. In other embodiments, the web server executes proprietary software, such as the INTERNET INFORMATION SERVICES products provided by Microsoft Corporation of Redmond, Wash., the ORACLE IPLANET web server products provided by Oracle Corporation of Redwood Shores, Calif., or the BEA WEBLOGIC products provided by BEA Systems of Santa Clara, Calif.

In some embodiments, the system may include multiple, logically-grouped remote machines 106. In one of these embodiments, the logical group of remote machines may be referred to as a server farm 438. In another of these embodiments, the server farm 438 may be administered as a single entity.

FIGS. 4B and 4C depict block diagrams of a computing device 100 useful for practicing an embodiment of the client(s) 102 or a remote machine 106. As shown in FIGS. 4B and 4C, each computing device 100 includes a central processing unit 421, and a main memory unit 422. As shown in FIG. 4B, a computing device 100 may include a storage device 428, an installation device 416, a network interface 418, an I/O controller 423, display devices 424a-n, a keyboard 426, a pointing device 427, such as a mouse, and one or more other I/O devices 430a-n. The storage device 428 may include, without limitation, an operating system and software. As shown in FIG. 4C, each computing device 100 may also include additional optional elements, such as a memory port 403, a bridge 470, one or more input/output devices 430a-n (generally referred to using reference numeral 430), and a cache memory 440 in communication with the central processing unit 421.

The central processing unit 421 is any logic circuitry that responds to and processes instructions fetched from the main memory unit 422. In many embodiments, the central processing unit 421 is provided by a microprocessor unit, such as: those manufactured by Intel Corporation of Mountain View, Calif.; those manufactured by Motorola Corporation of Schaumburg, Ill.; those manufactured by Transmeta Corporation of Santa Clara, Calif.; those manufactured by International Business Machines of White Plains, N.Y.; or those manufactured by Advanced Micro Devices of Sunnyvale, Calif. Other examples include SPARC processors, ARM processors, processors used to build UNIX/LINUX “white” boxes, and processors for mobile devices. The computing device 400 may be based on any of these processors, or any other processor capable of operating as described herein.

Main memory unit 422 may be one or more memory chips capable of storing data and allowing any storage location to be directly accessed by the microprocessor 421. The main memory 422 may be based on any available memory chips capable of operating as described herein. In the embodiment shown in FIG. 4B, the processor 421 communicates with main memory 422 via a system bus 450. FIG. 4C depicts an embodiment of a computing device 400 in which the processor communicates directly with main memory 422 via a memory port 403. FIG. 4C also depicts an embodiment in which the main processor 321 communicates directly with cache memory 440 via a secondary bus, sometimes referred to as a backside bus. In other embodiments, the main processor 421 communicates with cache memory 440 using the system bus 450.

In the embodiment shown in FIG. 4B, the processor 421 communicates with various I/O devices 430 via a local system bus 450. Various buses may be used to connect the central processing unit 421 to any of the I/O devices 430, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 424, the processor 421 may use an Advanced Graphics Port (AGP) to communicate with the display 424. FIG. 4C depicts an embodiment of a computer 400 in which the main processor 421 also communicates directly with an I/O device 430b via, for example, HYPERTRANSPORT, RAPIDIO, or INFINIBAND communications technology.

One or more of a wide variety of I/O devices 430a-n may be present in or connected to the computing device 400, each of which may be of the same or different type and/or form. Input devices include keyboards, mice, trackpads, trackballs, microphones, scanners, cameras, and drawing tablets. Output devices include video displays, speakers, inkjet printers, laser printers, 3D printers, and dye-sublimation printers. The I/O devices may be controlled by an I/O controller 423 as shown in FIG. 4B. Furthermore, an I/O device may also provide storage and/or an installation medium 416 for the computing device 400. In some embodiments, the computing device 400 may provide USB connections (not shown) to receive handheld USB storage devices such as the USB Flash Drive line of devices manufactured by Twintech Industry, Inc. of Los Alamitos, Calif.

Referring still to FIG. 4B, the computing device 100 may support any suitable installation device 416, such as a floppy disk drive for receiving floppy disks such as 3.5-inch, 5.25-inch disks or ZIP disks; a CD-ROM drive; a CD-R/RW drive; a DVD-ROM drive; tape drives of various formats; a USB device; a hard-drive or any other device suitable for installing software and programs. In some embodiments, the computing device 400 may provide functionality for installing software over a network 404. The computing device 400 may further comprise a storage device, such as one or more hard disk drives or redundant arrays of independent disks, for storing an operating system and other software. Alternatively, the computing device 100 may rely on memory chips for storage instead of hard disks.

Furthermore, the computing device 400 may include a network interface 418 to interface to the network 404 through a variety of connections including, but not limited to, standard telephone lines, LAN or WAN links (e.g., 802.11, Ti, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, 802.15.4, Bluetooth, ZIGBEE, CDMA, GSM, WiMax, and direct asynchronous connections). In one embodiment, the computing device 400 communicates with other computing devices 100′ via any type and/or form of gateway or tunneling protocol such as Secure Socket Layer (SSL) or Transport Layer Security (TLS). The network interface 418 may comprise a built-in network adapter, network interface card, PCMCIA network card, card bus network adapter, wireless network adapter, USB network adapter, modem, or any other device suitable for interfacing the computing device 100 to any type of network capable of communication and performing the operations described herein.

In further embodiments, an I/O device 430 may be a bridge between the system bus 150 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

A computing device 400 of the sort depicted in FIGS. 4B and 4C typically operates under the control of operating systems, which control scheduling of tasks and access to system resources. The computing device 400 can be running any operating system such as any of the versions of the MICROSOFT WINDOWS operating systems, the different releases of the UNIX and LINUX operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 3.x, WINDOWS 95, WINDOWS 98, WINDOWS 2000, WINDOWS NT 3.1-4.0, WINDOWS CE, WINDOWS XP, WINDOWS 7, WINDOWS 8, WINDOWS VISTA, and WINDOWS 10, all of which are manufactured by Microsoft Corporation of Redmond, Wash.; any version of MAC OS manufactured by Apple Inc. of Cupertino, Calif.; OS/2 manufactured by International Business Machines of Armonk, N.Y.; Red Hat Enterprise Linux, a Linus-variant operating system distributed by Red Hat, Inc., of Raleigh, N.C.; Ubuntu, a freely-available operating system distributed by Canonical Ltd. of London, England; or any type and/or form of a Unix operating system, among others.

The computing device 400 can be any workstation, desktop computer, laptop or notebook computer, server, portable computer, mobile telephone or other portable telecommunication device, media playing device, a gaming system, mobile computing device, or any other type and/or form of computing, telecommunications or media device that is capable of communication and that has sufficient processor power and memory capacity to perform the operations described herein. In some embodiments, the computing device 100 may have different processors, operating systems, and input devices consistent with the device. In other embodiments, the computing device 400 is a mobile device, such as a JAVA-enabled cellular telephone/smartphone or personal digital assistant (PDA). The computing device 400 may be a mobile device such as those manufactured, by way of example and without limitation, by Apple Inc. of Cupertino, Calif.; Google/Motorola Div. of Ft. Worth, Tex.; Kyocera of Kyoto, Japan; Samsung Electronics Co., Ltd. of Seoul, Korea; Nokia of Finland; Hewlett-Packard Development Company, L.P. and/or Palm, Inc. of Sunnyvale, Calif.; Sony Ericsson Mobile Communications AB of Lund, Sweden; or Research In Motion Limited of Waterloo, Ontario, Canada. In yet other embodiments, the computing device 100 is a smartphone, POCKET PC, POCKET PC PHONE, or other portable mobile device supporting Microsoft Windows Mobile Software.

In some embodiments, the computing device 400 is a digital audio player. In one of these embodiments, the computing device 400 is a digital audio player such as the Apple IPOD, IPOD TOUCH, IPOD NANO, and IPOD SHUFFLE lines of devices manufactured by Apple Inc. In another of these embodiments, the digital audio player may function as both a portable media player and as a mass storage device. In other embodiments, the computing device 100 is a digital audio player such as those manufactured by, for example, and without limitation, Samsung Electronics America of Ridgefield Park, N.J., or Creative Technologies Ltd. of Singapore. In yet other embodiments, the computing device 400 is a portable media player or digital audio player supporting file formats including, but not limited to, MP3, WAV, M4A/AAC, WMA Protected AAC, AEFF, Audible audiobook, Apple Lossless audio file formats, and .mov, .m4v, and .mp4 MPEG-4 (H.264/MPEG-4 AVC) video file formats.

In some embodiments, the computing device 400 comprises a combination of devices, such as a mobile phone combined with a digital audio player or portable media player. In one of these embodiments, the computing device 100 is a device in the Google/Motorola line of combination digital audio players and mobile phones. In another of these embodiments, the computing device 400 is a device in the IPHONE smartphone line of devices manufactured by Apple Inc. In still another of these embodiments, the computing device 400 is a device executing the ANDROID open source mobile phone platform distributed by the Open Handset Alliance; for example, the device 100 may be a device such as those provided by Samsung Electronics of Seoul, Korea, or HTC Headquarters of Taiwan, R.O.C. In other embodiments, the computing device 400 is a tablet device such as, for example and without limitation, the IPAD line of devices manufactured by Apple Inc.; the PLAYBOOK manufactured by Research In Motion; the CRUZ line of devices manufactured by Velocity Micro, Inc. of Richmond, Va.; the FOLIO and THRIVE line of devices manufactured by Toshiba America Information Systems, Inc. of Irvine, Calif.; the GALAXY line of devices manufactured by Samsung; the HP SLATE line of devices manufactured by Hewlett-Packard; and the STREAK line of devices manufactured by Dell, Inc. of Round Rock, Tex.

Having described certain embodiments of methods and systems for improving mastery of phonics skills following a computer-based, screening and diagnostic phonics assessment, it will now become apparent to one of skill in the art that other embodiments incorporating the concepts of the disclosure may be used. Therefore, the disclosure should not be limited to certain embodiments, but rather should be limited only by the spirit and scope of the following claims.

What is claimed is:

1. A method for improving mastery of phonics skills following a computer-based screening and diagnostic phonics assessment, the method comprising:
selecting, by a word selection module of an assessment engine executed by a first computing device, a word from a word database;
modifying, by the assessment engine, an administrator user interface displayed by the first computing device to include a display of the selected word and an interface element for scoring the selected word;
modifying, by the assessment engine, a subject user interface displayed by a second computing device to an assessment subject, the modification resulting in display of the selected word in the subject user interface;
receiving, by a feedback analysis module of the assessment engine, an input to the administrator user interface;
determining, by the feedback analysis module, that the input indicates the assessment subject incorrectly read the selected word;
providing, by the feedback analysis module, to a diagnoses module of the assessment engine, the selected word and a subset of the input;
diagnosing, by the diagnoses module, a level of mastery of a phonics skill of the assessment subject based upon the provided subset of the input; and
modifying, by the assessment engine, the administrator user interface to include a display of the diagnosed level of mastery and an identification of an activity for improving the diagnosed level of mastery.

2. The method of claim 1, wherein selecting the word further comprises:
identifying a time of year at which the word selection module is selecting the word;
identifying a type of word associated with the identified time of year; and
selecting a word of the type associated with the identified time of year.

3. The method of claim 2, wherein selecting the word further comprises identifying a time of year that is a month associated with a portion of an academic calendar.

4. The method of claim 2, wherein selecting the word further comprises identifying a time of year that is a month associated with a portion of a summer session.

5. The method of claim 2, wherein selecting the word further comprises identifying a time of year that is a month associated with a portion of a calendar year and independent of an academic calendar.

6. The method of claim 1, wherein selecting the word further comprises:
identifying a grade level of the assessment subject;
identifying a type of word associated with the identified grade level; and
selecting a word of the type associated with the identified grade level.

7. The method of claim 1, wherein diagnosing the level of mastery of the phonics skill of the assessment subject further comprises:
identifying, by the diagnoses module, a pattern associated with the selected word;
assigning, by the diagnoses module, to each of a plurality of portions of the selected word, a weight selected based upon the identified pattern;
analyzing, by the diagnoses module, the identification of the input to the administrator user interface;
generating, by the diagnoses module, a score for each of the plurality of portions of the selected word based upon the assigned weight and the analysis of the identification of the input; and
determining a level of mastery of the phonics skill of the assessment subject based upon the generated score.

8. The method of claim 1, wherein diagnosing the level of mastery of the phonics skill of the assessment subject further comprises:
identifying, by the diagnoses module, a pattern associated with the selected word;
identifying, by the diagnoses module, a time of year at which the identification of the input is received;
assigning, by the diagnoses module, to each of a plurality of portions of the selected word, a weight selected based upon the identified pattern and a weight selected based upon the identified time of year;
analyzing, by the diagnoses module, the identification of the input to the administrator user interface;
generating, by the diagnoses module, a score for each of the plurality of portions of the selected word based upon the assigned weight and the analysis of the identification of the input; and
determining a level of mastery of the phonics skill of the assessment subject based upon the generated score.

9. The method of claim 1, wherein diagnosing the level of mastery of the phonics skill of the assessment subject further comprises:
identifying, by the diagnoses module, a pattern associated with the selected word;
identifying, by the diagnoses module, a time of year at which the identification of the input is received;
identifying, by the diagnoses module, a grade level of the assessment subject;
assigning, by the diagnoses module, to each of a plurality of portions of the selected word, a weight selected based upon the identified pattern, the identified time of year, and the identified grade level;
analyzing, by the diagnoses module, the identification of the input to the administrator user interface;
generating, by the diagnoses module, a score for each of the plurality of portions of the selected word based upon the assigned weights and the analysis of the identification of the input; and
determining a level of mastery of the phonics skill of the assessment subject based upon the generated score.

10. The method of claim 1 further comprises identifying the activity for improving the diagnosed level of mastery.

11. The method of claim 10, wherein identifying the activity further comprises identifying a diagnostic that should be administered to the subject.

12. The method of claim 10, wherein identifying the activity further comprises identifying a phonics skill to be mastered based upon specific errors the subject made during the assessment.

13. The method of claim 10, wherein identifying the activity further comprises identifying at least one intervention designed to target at least one error made during the assessment.

14. A method for performing a computer-based diagnostic phonics assessment, the method comprising:
selecting, by a word selection module of an assessment engine executed by a first computing device, a first word from a word database;
modifying, by the assessment engine, an administrator user interface displayed by the first computing device to include a display of the selected first word and an interface element for scoring the selected first word;
modifying, by the assessment engine, a subject user interface displayed by a second computing device to an assessment subject, the modification resulting in display of the selected first word in the subject user interface;
receiving, by a feedback analysis module of the assessment engine, a first input to the administrator user interface;
determining, by the feedback analysis module, that the first input indicates the assessment subject correctly read the selected first word;
selecting, by the word selection module, a second word from the word database;
modifying, by the assessment engine, the administrator user interface to include a display of the selected second word and an interface element for scoring the selected second word;
modifying, by the assessment engine, the subject user interface, the modification resulting in display of the selected second word in the subject user interface;
receiving, by the feedback analysis module, a second input to the administrator user interface;
determining, by the feedback analysis module, that the second input indicates the assessment subject incorrectly read the selected second word;
providing, by the feedback analysis module, to a diagnoses module of the assessment engine, the selected second word and a subset of the input;
diagnosing, by the diagnoses module, a level of mastery of a phonics skill of the assessment subject based upon the provided subset of the input; and
modifying, by the assessment engine, the administrator user interface to include a display of the diagnosed level of mastery and an identification of an activity for improving the diagnosed level of mastery.

15. A non-transitory, computer-readable medium encoded with computer-executable instructions that, when executed on a computing device, cause the computing device to carry out a method for improving mastery of phonics skills following a computer-based, screening and diagnostic phonics assessment, the method comprising:
selecting, by a word selection module of an assessment engine executed by a first computing device, a word from a word database;
modifying, by the assessment engine, an administrator user interface displayed by the first computing device to include a display of the selected word and an interface element for scoring the selected word;
modifying, by the assessment engine, a subject user interface displayed by a second computing device to an assessment subject, the modification resulting in display of the selected word in the subject user interface;
receiving, by a feedback analysis module of the assessment engine, an input to the administrator user interface;
determining, by the feedback analysis module, that the input indicates the assessment subject incorrectly read the selected word;
providing, by the feedback analysis module, to a diagnoses module of the assessment engine, the selected word and a subset of the input;
diagnosing, by the diagnoses module, a level of mastery of a phonics skill of the assessment subject based upon the provided subset of the input; and
modifying, by the assessment engine, the administrator user interface to include a display of the diagnosed level of mastery and an identification of an activity for improving the diagnosed level of mastery.
